(19) United States
(12) Patent Application Publication
(10) Pub. No.: US 2026/0109152 A1
(43) Pub. Date: Apr. 23, 2026

(54) PRINTHEAD SYSTEM WITH NOZZLE REJUVENATION SYSTEM

(71) Applicant: Xerox Corporation, Norwalk, CT (US)

(72) Inventors: Travis Burt, Canandaigua, NY (US); Peter Gulvin, Webster, NY (US); Christine A. Steurrys, Williamson, NY (US); Steven R. Moore, Rochester, NY (US)

(21) Appl. No.: 18/918,703

(22) Filed: Oct. 17, 2024

(51) Int. Cl. B41J 2/19; B41J 2/165; B41J 2/175

(52) U.S. Cl. CPC B41J 2/19; B41J 2/1652; B41J 2/16579; B41J 2/17596; B41J 2002/16597; B41P 2251/112

(57) ABSTRACT

A printer applies pressure through an ink supply system to enable degassed ink to flow through an ink delivery system to remove air bubbles from the printhead.

### FIELD OF THE DISCLOSURE

The present disclosure relates to a printhead system. More specifically, the present disclosure relates to a printhead system having a system for removing air bubbles from print head nozzles.

### BACKGROUND

Printheads are critical components in various printers such as inkjet and thermal printers. Printheads include an arrangement of nozzles which eject ink. The functionality and number of nozzles affect the resolution and quality of the print. Additionally, printheads include pressure generating devices that cause the ink to be ejected from the nozzles. Example pressure generators include piezoelectric crystals, heating elements or similar devices.

Printheads additionally include or are associated with ink delivery systems, ink tubes, pumps, valves, and other various components to create printed products. A common issue with printheads occurs with nozzles not firing properly. This is a particular problem in inkjet printers, which can have a faceplate with hundreds or even thousands of tiny orifices (i.e., nozzles) through which ink is ejected. Due to the vast number of nozzles, small contaminants such as air bubbles can create issues, causing a nozzle to become blocked and fail to eject ink, which is a phenomenon sometimes referred to as a “missing” nozzle condition.

Typically, missing nozzles can be compensated for via software and other control systems. However, if the issues persist and more nozzles are affected, issues with resolution and quality of images can occur. A service technician is typically required to disassemble the printer and components of the printhead ink delivery system to resolve such issues. However, this is a time-consuming and tedious process that requires disassembling the printer and the pumps contained in the ink delivery system. In some cases, flushing ink through the printhead can remove contaminants especially when the contaminants include air bubbles, but typically only if the bubbles are very small.

The present disclosure relates to improvements that address at least some of the limitations and issues described above.

### SUMMARY

The present disclosure is related to removing contaminants such as air bubbles from marking systems in a time and cost-effective manner. The disclosure provides a marking system that includes a printhead. The printhead includes a plurality of nozzles that are configured to eject ink. The marking system additionally includes a fluid supply system that is configured to supply ink to printhead. The fluid supply system includes an ink reservoir fluidly positioned to hold the ink for delivery to the printhead, a degasser fluidly coupled to a conduit that is positioned to supply the ink from the degasser to the ink reservoir, the degasser configured to degas the ink as ink passes therethrough, and a pump fluidly configured to provide pressure to one or more components of the fluid supply system. The marking system additionally includes a control system. The control system controls the ejection of ink from the plurality of nozzles. In response to detection of a missing nozzle condition in the printhead, the control system can activate a protocol that includes initiating one or more cycles. The cycles include operating the pump at a pressure that is lower than a normal operating pressure of the pump to eject the degassed ink through the plurality of nozzles until the missing nozzle condition ends, a threshold number of cycles have completed, or a threshold period of time is reached.

The present disclosure additionally provides a method of removing gas from a marking system. The method includes providing a marking system. The marking system includes a printhead including a plurality of nozzles a control system, and an ink supply system. The ink supply system includes an ink reservoir fluidly positioned to hold the ink for delivery to the printhead, a degasser fluidly coupled to a conduit that is positioned to supply the ink from the degasser to the ink reservoir, the degasser configured to degas the ink as ink passes therethrough, and a pump fluidly configured to provide pressure to one or more components of the fluid supply system. By the control system, in response to detecting a missing nozzle condition in the printhead, the control system activates a protocol that comprises operating the pump at a pressure that is lower than a normal operating pressure of the pump to create an ink flow through the plurality of nozzles until the missing nozzle condition ends, a threshold number of cycles have completed, or a threshold period of time is reached.

### BRIEF DESCRIPTION OF THE DRAWINGS

FIG. 1 is a diagram of a marking system in accordance with the principles of the present disclosure.

FIG. 2 illustrates elements of an ink pump that may be used in the marking system of FIG. 1.

FIG. 3 illustrates elements an ink chamber and nozzle of a printhead that may be used in the marking system of FIG. 1.

FIG. 4 is a flowchart outlining a method of clearing contaminants such as air bubbles from a printhead in accordance with the principles of the present disclosure.

### DETAILED DESCRIPTION

In the various embodiments, the devices, methods and systems of the present disclosure relate to marking systems of printers that include printheads. Specifically, the present disclosure relates to methods, systems, and parts of printheads and ink delivery systems. As discussed above, a common issue occurs with nozzles of printheads and contaminants affecting nozzles. For example, air bubbles can clog ink delivery systems blocking nozzles and affecting print quality (e.g., streaks and lines, color inconsistencies, increased ink usage, etc.). Moreover, such issues often require a service technician which can be time consuming and, in some cases, costly. The present disclosure relates to a marking system with improved components and systems for rejuvenating missing jets.

As discussed herein, the term marking system refers to the elements of a printer that deliver ink to a substrate, including the printhead(s) and components that deliver ink to the printhead(s). A printer may include an outer housing that stores the marking system and includes a user interface which allows a user to interact with the system. Color printers typically have multiple printheads. As housings and user interfaces of printers are well known, the present disclosure mainly focuses on marking systems and improvements thereof.

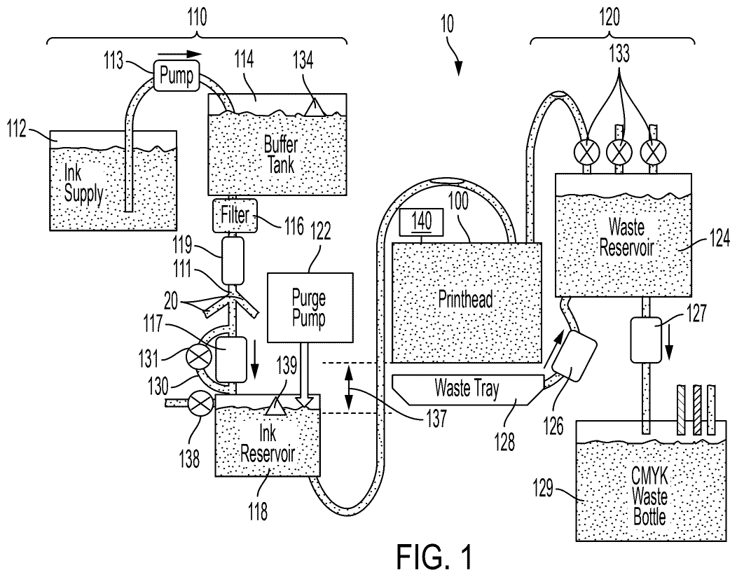

Referring to FIG. 1, elements of a marking system 10 are depicted. The marking system includes a printhead 100, a fluid supply system 110, and a waste system 120. The printhead 100 includes hundreds, and in some cases, thousands of small nozzles that are responsible for ejecting ink and creating images on the surface of a medium. The fluid supply system 110 provides ink from one or more ink sources to the printhead 100. The waste system 120 manages and removes excess ink, debris and contaminants from the printhead 100. The marking system 10 also includes a control system 140. The control system 140 includes a microcontroller or processor with embedded software and/or a memory containing software that is configured to enable the control system 140 to control the operations of the marking system 10 and the components thereof.

In operation, purge cycles can purge ink through the printhead 100, after which ink is collected via the waste system 120. This process can help extend the life of the marking system 10 and help to prevent clogs in the printhead 100. However, purge cycles, in some cases, are unable to prevent or remove all clogs, and additional procedures are often required. As discussed above, contaminants can be costly and time consuming.

To address this, this document describes a system and process in which ink may be drooled through the printhead nozzles to remove air therefrom. In particular, degassed ink is drooled through the printhead nozzles at volumetric flow rates and/or pressures that are much less than those used in a typical purge process. This can allow air bubbles to slowly dissolve into the degassed ink and be removed. In some cases, especially when larger air bubbles are causing clogs, flushing ink through the nozzles slowly by drooling can be especially beneficial.

With continued reference to FIG. 1, the fluid supply system 110 includes an ink supply 112, a buffer tank 114, a filter 116 and degasser 119, and an ink reservoir 118. The fluid supply system 110 additionally includes a first ink supply pump 113 and a second ink supply pump 117. The first ink supply pump 113 is positioned in a conduit between the ink supply 112 and buffer tank 114, and during operation it is configured to draw and transport ink from the ink supply 112 to the buffer tank 114. The second ink supply pump 117 is positioned in a conduit 111 between buffer tank 114 and the ink reservoir 118, and it is positioned to draw and transport ink from the buffer tank 114, through the filter 116 and degasser 119, to the ink reservoir 118.

In some embodiments, the buffer tank 114 is the main ink source during use of the marking system 10. It holds ink that is available for immediate use by the printhead 100. The buffer tank 114 may include an ink level detection sensor 134 that can determine whether the marking system 10 requires more ink for proper operation. For example, the ink level detection sensor 134 may include floats, optical sensors, electrical resistance sensors, pressure sensors, or other suitable mechanisms.

In some embodiments, the buffer tank 114 includes separate containers which hold different ink colors. Similarly, multiple ink supplies 112 of different colors may be provided, and multiple ink reservoir 118 compartments may be included. To simplify the system, a single conduit and a single pump are depicted as fluidly interconnecting these elements. However, in practice multiple branches may connect these elements. For example, several branches 20 of conduit 111 may lead various colors of ink out of the tank 114 is attached to separate branches 20. The branches 20 may lead to other ink pumps, ink reservoirs and components discussed hereinafter. For example, in some embodiments, the buffer tank 114 may fluidly attached to three branches 20 with separate ink pumps, and printheads that make up a marking system. It will be appreciated that there may be more, or fewer, branches 20 in the system and connected to the same or different printheads 100 to form the marking system 10.

The ink supply 112 may be a bottle, a tank, cartridge, ink stick, or other container, typically of a size larger than the size of a corresponding container of the buffer tank 114, to provide a reserve of ink that is used to replenish ink levels in the buffer tank 114 which the levels are below a threshold. In some embodiments that are high volume systems, the ink supply 112 may include a continuous ink supply system with one or more in tanks that are positioned outside of the marking system. In some embodiments, when the ink level sensor 134 determines that the buffer tank 114 is low on ink. When the buffer tank 114 is low on ink, the ink supply 112 may be switched to a full ink supply without stopping operation of the marking system 10 as the buffer tank 114 is separate from the ink supply 112.

As discussed above, the buffer tank 114 is fluidly attached to a filter 116 and/or degasser 119 that are positioned to filter and degas the ink before the ink reaches the ink reservoir 118. As depicted, the filter 116 and degasser 119 are arranged prior to (i.e., upstream of) fluid traveling through the second ink supply pump 117 and various branches 20. It will be appreciated that the filter 116 and degasser 119 may be positioned at other locations in the conduit, such as after (i.e., downstream of) the second ink supply pump 117. The filter 116 is configured to remove impurities from the ink prior to the ink reaching ink reservoir 118 and the printhead 100. The filter 116 may be a membrane filter, a fibrous filter, a mesh filter, or a different type of appropriate filter for removing impurities. In some embodiments, the degasser 119 may be configured as a membrane that allows air particles to be pulled through while routing the ink towards the ink reservoir 118. The degasser 119 may also remove other dissolved gases or undissolved gases from the ink prior to the ink reaching the printhead 100. As discussed above, the degasser 119 may be a membrane degasser in some embodiments. In other embodiments, the degasser 119 may also be a vacuum degasser, an ultrasonic degasser, or other degasser.

The ink moves fluidly through the ink delivery system 110 through the second ink supply pump 117. The second ink supply pump 117 fills the ink reservoir 118. The top of the volume of ink in reservoir 118 is positioned below the face of the printhead 100, thus applying a negative pressure at the print head nozzles. A negative pressure is required to form a meniscus (e.g., a curved surface of liquid ink at the opening of the printhead) in the nozzle, which prevents the nozzles from drooling ink during normal operation.

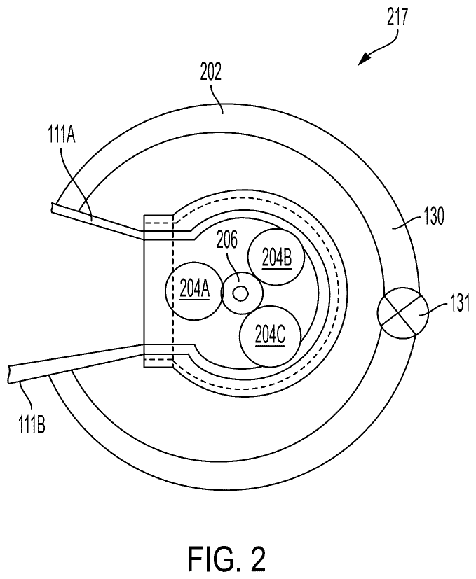

In some embodiments, one or more of the ink supply pumps (such as second ink supply pump 117) may be a peristaltic pump. Referring to FIG. 2, a schematic diagram of a peristaltic pump 217 is shown. The peristaltic pump 217 includes a housing 202, rollers 204A-204C, and a rotor 206 which the rollers 204A-204C rotate about. FIG. 2 also depicts a first conduit segment 111A transporting ink from the buffer tank (114 in FIG. 1) to the peristaltic pump 217 and second conduit segment 111B extending out of the peristaltic pump 217 towards the ink reservoir 118. Each of the conduit segments 111A, 111B is configured as a malleable tubing that resiliently deforms. Ink transports from the first conduit segment 111A to second conduit segment 111B through positive pressure generated by the rollers 204A-204C deforming the tubing and creating kinks as the rollers 204A-204C rotate about the rotor 206. In this manner, ink is transported through the pump 217 as the rotor 206 rotates the rollers and kinks the tubing when rotor 206 seizes movement. In this manner, the peristaltic pump 217 acts as a point where ink stops flowing when not in use. Although a peristaltic pump is shown by way of illustration, other pumps may also be used such as diaphragm pumps, piston pumps, rotary lobe pumps, or a different suitable pump.

Returning to FIG. 1, the second ink supply pump 117 (which may be peristaltic pump 217 of FIG. 2) is positioned at an elevation that is lower than that of the buffer tank 114. The ink reservoir 118 is positioned at an elevation that is lower than that of the buffer tank 114 and the second ink supply pump 117. With this configuration, gravity helps to pull ink from the buffer tank 114 towards the second ink supply pump 117 and the ink reservoir 118.

Optionally, in some embodiments a bypass tube 130 may be attached to the inlets and outlets of second ink supply pump 117, and/or to segments the conduit 111 leading to the inlet and from the output of the second ink supply pump 117. The bypass tube 130 thus provides a path through which ink may flow buffer tank 114 to the ink reservoir 118 that is an alternate (or supplement) to the path that runs through the second ink supply pump 117.

The bypass tube 130, if included, includes, or is connected to, a valve 131. The valve 131 is configured to remain closed during normal operation. When ink is drooled through the printhead 100 to remove air bubbles (discussed in further detail below), the valve 131 may be opened and ink can then freely flow through the bypass tube in a path to the ink reservoir 118 and printhead 100. The bypass tube 130 allows for contaminants such as air bubbles to be removed from the print head, discussed in further detail below.

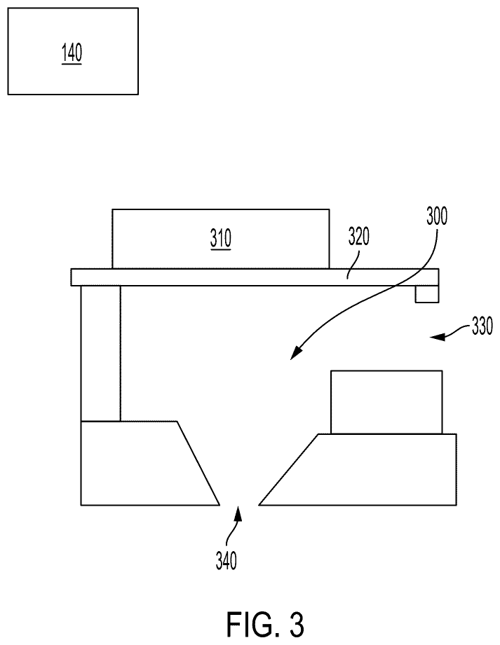

The ink reservoir is positioned below the nozzles of the printhead to provide a negative pressure 137 which prevents ink from drooling out of the nozzles in the printhead 100 under normal operating conditions. The ink reservoir 118 is additionally attached to a purge pump 122. The purge pump 122 allows for pressure to be placed on the ink in the ink reservoir. This pressure causes ink to flow through the print head, removing contaminants. Additionally, the purge pump 122 may cause initial ink flow from the reservoir 118 to the printhead. The printhead 100 includes ink nozzles that temporarily hold ink before the printhead 100 ejects droplets of ink. The ink is periodically pushed through the nozzles using the purge pump 122 to clear contaminants or dried ink to prepare the nozzles for printing (see FIG. 3).

In some embodiments, the printhead 100 is a piezoelectric printhead. Referring to FIG. 3, example elements associated with an ink chamber 300 of the printhead 100 are shown. The ink chamber 300 includes one or more piezoelectric elements 310 attached to a diaphragm 320. Ink flows into the chamber at an inlet 330 and out of the chamber through a nozzle 340. The piezoelectric element 310 changes shape or size when an electric current is applied to it. During operation, the control system 140 (which also appeared in FIG. 1) causes a voltage to be applied to the piezoelectric material causing the piezoelectric element 310 to deform. Each cycle of the voltage waveform will cause the piezoelectric material to expand and eject the ink, and then contract to immediately refill the chamber. The deformation causes pressure to build on the diaphragm 320 and within the ink chamber 300. This causes ink, in a controlled and precise manner, to be ejected from the nozzle 340 under a controlled pressure.

Returning to FIG. 1, during a purge cycle, the waste ink is directed into the waste system 120 to allow for storage and proper disposal. The waste system 120 may include a waste tray 128, a waste reservoir 124, a waste bottle 129, and first and second waste transport pumps 126, 127.

The waste tray 128 may be positioned under nozzles of the printhead 100 and serve as an initial collection point of ink and may receive ink during purge cycles or other operations where ink needs to be disposed of. The waste tray 128 is fluidly connected to the waste reservoir 124 and transfers ink thereto via a conduit with assistance from the first waste transport pump 126. Optionally, the waste reservoir 124 also may be additionally connected directly to the printhead 100 via one or more conduits 133. The printhead 100 transfers ink directly to the waste reservoir 124 during a manifold purge. A manifold purge is used to move large volumes of fluid through the print head. This is primarily done to change the fluid type in the printhead, remove air from the ink lines or when debugging a problem that cannot be resolved by a normal purge. The waste reservoir 124 may be fluidly attached to other printheads via the conduits 133. In FIG. 1, two additional conduits 133 are depicted. In some other examples, more or fewer conduits may be fluidly attached to the waste reservoir 124.

The waste reservoir 124 serves as a temporary holding tank and is fluidly attached to the waste bottle 129. The waste bottle 129 receives all the unused, or excess ink from the printer during operation and may be periodically changed or emptied during usage. The ink may be transferred to the waste bottle 129 from the waste reservoir 124 via a conduit with assistance from the second waste transport pump 127. The waste bottle 129 is typically larger than the waste reservoir 124 to reduce the frequency of changing the waste bottle 124.

Due to the complexities of the marking system 10, small contaminants such as air bubbles may enter the system during normal operation. Bubbles can form in printheads from air ingestion, cavitation, temperature changes, or other normal operations. In some cases, removal of the contaminants is possible through standard operation of the purge system 120. In some other cases, additional steps are required to remove contaminants. One method for removal of air includes drooling degassed ink, through the ink nozzles. Degassed ink will absorb small amounts of air until saturated. By slowly passing ink by the air bubble, this allows continual availability of degassed ink, thus air absorption continues until the air has been completely absorbed. In some cases, the ink pump 117 needs to be partially disassembled to flush ink through the printhead 100. For example, the ink pump 117 may need to be disassembled (e.g., when the ink pump 117 is configured as a peristaltic pump).

In some methods of the present disclosure, ink may be drooled through the printhead by stopping operation of the second ink supply pump 117 and opening the valve 131 of the bypass tube 130, thereby allowing ink to flow therethrough so as to intentionally overfill the ink reservoir 118 until the surface of its ink volume is higher in elevation than the nozzles of the printhead 100, resulting in ink to drool out of the nozzles in a controlled flow. Additionally, the piezoelectric elements of the printhead 100 may be activated, which improves the efficiency in which the air is absorbed by the degassed ink. The voltage level sent to the piezoelectric elements during this process is a much lower magnitude than that used during normal printing. It creates movement of the ink in the nozzle, but does not have enough power to eject the ink. For example, in various embodiments the peak-to-peak voltage for a firing waveform (i.e., normal printing operation) may be approximately 70V, or any voltage in a range from 50V to 96V. In addition, in various embodiments the peak-to-peak voltage applied for a non-firing waveform (i.e., during a drool process) may be approximately 20V, or any voltage in a range from 10V to 30V. The voltage may be applied by two power supplies, one that will apply a positive voltage of approximately 48V to eject ink during normal operation and the other to apply a voltage of approximately −48V causing the piezoelectric elements to flex in the opposite direction and refill the nozzle. In each case, other voltages are possible. If the second ink supply pump 117 is positioned downstream of the filter 116 and degasser 119, the ink passing through the bypass tube 130 and to the printhead 100 is be filtered and degassed.

In some embodiments, the process of drooling degassed ink through the printhead 100 may be triggered by any of various procedures. In some examples, the methods may be automated when air bubbles or contaminants are detected, such as by a pressure sensor generating data that the control system 140 uses to determine that an abnormal pressure in the printhead, such as if the pressure is at least a threshold amount larger than a known normal operating pressure, or the pressure being above a normal operating range. In other examples, the control system 140 may prompt a user to run a drool cycle. In yet other examples, a camera may capture an image of a content printed on a substrate, the system (or a person) may compare the content to an expected image, determine that a missing jet condition exists, and the drool cycle should be triggered if the images are substantially different, or if the printed image fails to satisfy a quality requirement.

Optionally, the drooling process described in this document may be implemented after a normal purge process has been run. For example, when a threshold number of nozzles are not functioning properly as determined by the control system, such that the quality of printing is affected, the control system may signal to the user or the system that a purge cycle should be ran, or a purge cycle may be ran through automation. The purge pump and/or other pumps of the system will increase the pressure and flow rate of the ink running through the printhead during the purge operation. If the missing jet condition has not been cleared by the purge system after a threshold period of time, or after a threshold number of purge cycles have been run, the system may implement the drool procedure described in this document, where the pump reduces the pressure so that the ink runs more slowly through the system and thus can be said to drool through the printhead nozzles. In addition, in some embodiments the system may alternate cycles in which one or more purge procedures are run, then one or more drool procedures. The cycles may continue for a set number of cycles, for a set period of time, or until the missing jet condition is resolved.

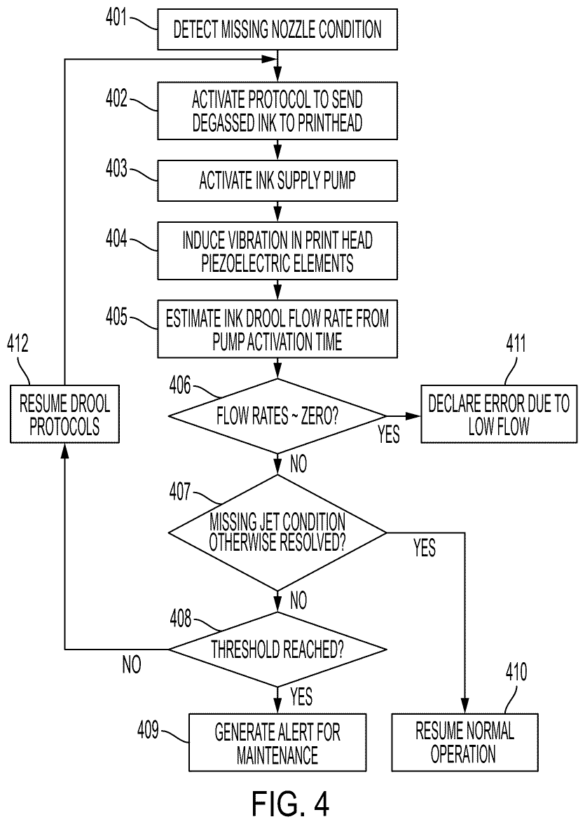

With reference to FIG. 4, a flowchart depicts operations, executed by the control system, to drool degassed ink through the printhead assembly to remove contaminants. At 401 the marking system may detect a missing nozzle condition. Detection of the missing nozzle condition may occur by the control system 140 in response to a missing jet measurement.

Optionally, other conditions can trigger the drool protocol at step 402. For example, the control system may be programmed to trigger a purge protocol automatically upon the system reaching a threshold operational condition, such as when the printhead has printed a threshold number of sheets since the last purge, when the printhead has consumed a threshold amount of ink since the last purge, or detection of other faults in the system. After the standard purge is completed one or more times, the system may then initiate the drool procedure at 402 if the missing jet condition has not yet resolved. In other embodiments, activating the protocol may comprise generating a visual and/or audible prompt that invites a user to manually start the drool protocol.

To begin, at 403 the drool protocol will activate one or more of the pumps in the ink supply system (e.g., first or second ink supply pumps 113, 117, or the purge pump 122) and use the pressure generated by the pump to direct degassed ink to the printhead 100. In some embodiments, the pressure generated may be a relatively low pressure as compared to the pressure generated during a normal purge operation in which the ink is purged from the nozzles as part of a normal maintenance operation (clearing dried ink or contamination). The pressure is sufficient to overcome the meniscus formed in the printhead nozzles and cause a slow and controlled drooling. For example, the pressure generated by a pump during a drool operation may be from about 1% to about 10% of that induced by the pump during normal purge operation. Normal operation of the purge pump generates a much higher pressure (20-45 Kpa) than that used by the drool method (0.2-1 Kpa). By way of example, if a purge pump 122 induces about 7 psi of pressure during the normal purge operation, it may be controlled to induce about 0.025 psi to about 0.5 psi during the drool operation.

When a positive pressure, above a threshold, is sensed by the printhead, the piezoelectric elements are activated and begin to vibrate at 404.

Various methods may be used to determine when the missing jet condition has been resolved 407. For example, as noted above, the system may pause the drool protocol and print a sheet, and the printed image may be compared to an expected image to determine whether the printed image exhibits a threshold print quality and/or similarity to the expected image. The system also may continue to monitor pressure and determine that the condition is resolved (407: YES) if the pressure is within a defined pressure range or distance from a threshold. As another option, as the ink drools from the printhead, at 405 the control system may estimate the ink flow rate by measuring the amount of total time that the ink pump 117 is activated to refill the ink reservoir 118. For example, if ink is not drooling from the printhead due to a flow obstruction, the controller will detect this condition by determining that the activation time of the pump is zero or approximately zero. If the flow rates are estimated to be zero or approximately zero by this process (406: YES), the controller may stop the protocol and provide an alert that further service action is needed 411.

If the estimated ink flow rates are not substantially non-zero (406: NO [symbol] , and/or if the missing jet condition was not otherwise cleared (407: NO), the system may resume the drool protocol continue to monitor the flow rates until a threshold is reached 408. The threshold may be a period of time and/or a number of purge and/or drool cycles. If the flow rates remain not substantially equal or the missing jet condition is not otherwise cleared before the threshold is reached (408: NO), the protocol may continue at 412. If the threshold is reached and (a) the monitored flow is still not substantially equalized or (b) the missing jet condition is not otherwise cleared, (408: YES), an alert may be generated for maintenance 409 and, optionally, the protocol may be stopped. In some examples, the above method may be automated, for example if a pressure sensor detects that there is excess pressure in the printhead. In other examples, a user may be alerted that the method should be initiated and can select a time at which the method may be initiated.

In one example protocol for providing degassed ink to the printhead in steps 402-403, with reference to FIG. 1, the purge pump 122 may apply pressure to the ink within the ink reservoir 118. The purge pump 122 causes air pressure above the ink in the ink reservoir 118. In operation, the purge pump 122 may apply pressure sufficient to cause ink to flow from the nozzles. The necessary pressure may be approximately equal to the density of the ink multiplied by delta h which is equal to the height of the top of the ink surface in the ink reservoir by minus the height of the printhead 100. The piezoelectric elements may be activated after the ink has begun flowing through the nozzles, although optionally they can be activated earlier in the process. The pressure applied by the purge pump in the drool operation is relatively low as compared to normal purge operation. For example, the pressure used in the drool protocol may be approximately 0.25 PSI, about 0.3 PSI, about 0.4 PSI, about 0.5 PSI or a different pressure sufficient to cause ink to flow through the nozzles.

In a first option of the purge protocol, degassed ink may be provided to the printhead via the bypass line 130 as discussed above. Other protocols are discussed in further detail below. In a second example protocol, the marking system may close ink reservoir purge valves and cause ink to flow using the second ink supply pump 117. Optionally, one or more purge valves 138 may be connected to the ink reservoir so that unsustainable pressures do not build within the ink reservoir 118 during normal operation. During normal operation, the purge valves will be open to atmospheric pressure so that pressure in the ink reservoir does not build substantially beyond atmospheric pressure. During a purge process, the purge valves 138 will be closed, and the pressure within the ink reservoir 118 is slowly allowed to build above atmospheric pressure, which forces the ink within the ink reservoir 118 to flow into the printhead 100 and the respective chambers of the ink head.

In a third example, the second ink supply pump 117 may cause ink to flow into the ink reservoir with the purge valves 138 opened. This causes the level of ink in the ink reservoir 118 to increase and therefore hydrostatically increase the pressure of ink that flows to the printhead 100. When the ink is flowing through the nozzles 100, the piezoelectric elements may be activated to increase the transfer efficiency of air molecules to the degassed ink. Because the ink level is building within the ink reservoir 118, it is important to ensure that ink does not rise into the purge valves 138. To protect against this, an ink level sensor 139 may be mounted within the ink reservoir 118 to alert the system to stop the process, or otherwise generate an alert, in response to detecting a threshold ink level, so that ink does not reach the purge valves. For example, a pressure sensor may detect the hydrostatic pressure at a position within the ink reservoir. Alternatively, other sensors, such as a float sensor or other ink level sensor, may also be used.

It will be appreciated that the above examples may be used in systems with multiple printheads. For example, a typical printer may include three separate printheads. In typical printers, printheads must be purged simultaneously. In some cases, contaminants occur in all printheads, and flushing ink through all of the printheads is beneficial. However, in some cases, blockages or contaminants occur in only one printhead. Thus, the above methods also may be used only in a single printhead.

In summary, the present disclosure relates to removing contaminants such as air bubbles from marking systems in a time and cost-effective manner. The disclosure provides a marking system that includes a printhead. The printhead includes a plurality of nozzles that are configured to eject ink. The marking system additionally includes a fluid supply system that is configured to supply ink to printhead. The fluid supply system includes an ink reservoir fluidly positioned to hold the ink for delivery to the printhead, a degasser fluidly coupled to a conduit that is positioned to supply the ink from the degasser to the ink reservoir, the degasser configured to degas the ink as ink passes therethrough, and a pump fluidly configured to provide pressure to one or more components of the fluid supply system. The marking system additionally includes a control system. The control system controls the ejection of ink from the plurality of nozzles. In response to detection of a missing nozzle condition in the printhead, the control system can activate a protocol that includes initiating one or more cycles. The cycles include operating the pump at a pressure that is lower than a normal operating pressure of the pump to eject the degassed ink through the plurality of nozzles until the missing nozzle condition ends, a threshold number of cycles have completed, or a threshold period of time is reached.

In some embodiments, the pump is a purge pump that is fluidly coupled to the ink reservoir, and the pump maybe configured to apply pressure to the ink reservoir. The pressure causes the ink to move from the ink reservoir to the printhead and provides ink to the plurality of nozzles.

In other embodiments, the marking system includes a purge valve coupled to the ink reservoir. The purge valve is configured to bleed to atmospheric pressure allowing for the ink reservoir to maintain atmospheric pressure during normal operation. In such embodiments, the protocol may further include closing the purge valve.

In some embodiments, the marking system includes a peristaltic pump fluidly connected to the conduit. During operation, the peristaltic pump draws the ink therethrough via vacuum pressure and transports the ink from the degasser to the ink reservoir via the conduit. The peristaltic pump acts as a stop when not in operation.

In other embodiments, the missing nozzle condition includes the control system detecting that at least a threshold amount of the plurality of nozzles are not operating.

In some embodiments, the missing nozzle condition includes an image quality of a document printed by the marking system not meeting a threshold image quality measure.

In some embodiments, the pressure at which the pump is operated during the protocol is a pressure from about 1% to about 10% of the standard operating pressure of the pump during typical printing operations of the marking system. In some embodiments, the pressure during the protocol is in a range of 0.25 PSI to 0.5 PSI.

In some embodiments, the pump is a purge pump. The purge pump is fluidly coupled to the ink reservoir, and configured to apply pressure to the ink reservoir and controls the pressure applied to the ink as the ink moves from the ink reservoir to the printhead and through the plurality of nozzles. The system may further include an ink supply pump that is a peristaltic pump fluidly connected to the conduit. During operation, the peristaltic pump draws the ink therethrough via vacuum pressure and transports the ink from the degasser to the ink reservoir via the conduit, and acts as a stop when not in operation.

In some embodiments, the protocol includes a drool protocol. In these embodiments, before initiating the drool protocol, the method initiates a purge protocol in which the pump increases pressure applied to the one or more components of the fluid supply system. After the purge protocol, the drool protocol is initiated and during the drool protocol, the pump reduces the pressure applied to the one or more components of the fluid supply system.

The present disclosure additionally provides a method of removing gas from a marking system. The method includes providing a marking system. The marking system includes a printhead including a plurality of nozzles a control system, and an ink supply system. The ink supply system includes an ink reservoir fluidly positioned to hold the ink for delivery to the printhead, a degasser fluidly coupled to a conduit that is positioned to supply the ink from the degasser to the ink reservoir, the degasser configured to degas the ink as ink passes therethrough, and a pump fluidly configured to provide pressure to one or more components of the fluid supply system. By the control system, in response to detecting a missing nozzle condition in the printhead, the control system activates a protocol that comprises operating the pump at a pressure that is lower than a normal operating pressure of the pump to create an ink flow through the plurality of nozzles until the missing nozzle condition ends, a threshold number of cycles have completed, or a threshold period of time is reached.

In some embodiments, the pump is a purge pump that is fluidly coupled to the ink reservoir and when the protocol is activated, the protocol causes purge pump to reduce the pressure applied to the ink as the ink moves from the ink reservoir to the printhead.

In some embodiments, the ink supply system includes a purge valve coupled to the ink reservoir and configured to bleed to atmospheric pressure allowing for the ink reservoir to maintain atmospheric pressure during normal operation. The protocol may further include closing the purge valve.

In some embodiments, the ink supply system further includes a peristaltic pump fluidly connected to the conduit. During operation, the peristaltic pump draws the ink therethrough via vacuum pressure and transports the ink from the degasser to the ink reservoir via the conduit. The peristaltic pump acts as a stop when not in operation.

In some embodiments, detecting the missing nozzle condition comprises detecting that at least a threshold amount of the plurality of nozzles are not operating.

In some embodiments, detecting the missing nozzle condition comprises detecting that an image quality of a document printed by the marking system not meeting a threshold image quality measure

In some embodiments, the pressure at which the pump is operated during the protocol is a pressure from about 1% to about 10% of the normal operating pressure of the pump. In some embodiments, the pressure during the protocol is in a range of 0.25 PSI to 0.5 PSI.

In some embodiments, the pump is a purge pump that is: fluidly coupled to the ink reservoir, and configured to control pressure applied to the ink as the ink moves from the ink reservoir to the printhead. In some embodiments, the system further includes an ink supply pump that is a peristaltic pump fluidly connected to the conduit and configured to draw the ink therethrough via vacuum pressure during operation and transport the ink from the degasser to the ink reservoir via the conduit. The peristaltic pump additionally may act as a stop when not in operation.

In some embodiments, the protocol includes a drool protocol. In these embodiments, before initiating the drool protocol, the method initiates a purge protocol in which the pump increases pressure applied to the one or more components of the fluid supply system. After the purge protocol, the drool protocol is initiated and during the drool protocol, the pump reduces the pressure applied to the one or more components of the fluid supply system.

The term “approximately,” when used in connection with a numeric value, is intended to include values that are close to, but not exactly, the number. For example, in various embodiments, the term “approximately” may include values that are within +/−1% of the value, +/−5% of the value, +/−10 percent of the value, or any value or fraction thereof between any or all of the values. The term “approximately,” when used in connection with a numeric value at or near zero, is intended to include values that are close to, but not exactly, zero. For example, in various embodiments, the term “approximately” may include values that are within +/−0.1 of the value, +/−0.01 of the value, +/−0.001 of the value, or any other value or fraction thereof between any or all of these values. The term “substantially,” when used in connection with a numeric value, is intended to mean approximately, within a threshold tolerance that is a percentage corresponding to any of the percentages described in the previous sentence.

This disclosure is not limited to the particular systems, methodologies or protocols described, as these may vary. The terminology used in this description is for the purpose of describing the particular versions or embodiments only and is not intended to limit the scope. It will be understood that terms such as “same,” “equal,” “planar,” or “coplanar,” as used herein when referring to orientation, layout, location, shapes, sizes, amounts, or other measures do not necessarily mean an exactly identical orientation, layout, location, shape, size, amount, or other measure, but are intended to encompass nearly identical orientation, layout, location, shapes, sizes, amounts, or other measures within acceptable variations that may occur, for example, due to manufacturing processes. The term “substantially” may be used herein to emphasize this meaning, unless the context or other statements clearly indicate otherwise. For example, items described as “substantially the same,” “substantially equal,” or “substantially planar,” may be exactly the same, equal, or planar, or may be the same, equal, or planar within acceptable variations that may occur, for example, due to manufacturing processes and/or tolerances. The term “substantially” may be used to encompass this meaning, especially when such variations do not materially alter functionality.

It will be understood that various modifications may be made to the embodiments disclosed in this document. Likewise, the above disclosed methods may be performed according to an alternate sequence. Therefore, the above description should not be construed as limiting, but merely as examples of the various embodiments. Those skilled in the art will envision other modifications within the scope and spirit of the claims appended to this document.

1. A marking system comprising:
a printhead comprising a plurality of nozzles configured to eject ink;
a fluid supply system configured to supply ink to printhead, the fluid supply system comprising:
an ink reservoir fluidly positioned to hold the ink for delivery to the printhead,
a degasser fluidly coupled to a conduit that is positioned to supply the ink from the degasser to the ink reservoir, the degasser configured to degas the ink as ink passes therethrough, and
a pump fluidly configured to provide pressure to one or more components of the fluid supply system; and
a control system configured to:
control the ejection of ink from the plurality of nozzles, and
in response to detection of a missing nozzle condition in the printhead, activate a protocol that comprises initiating one or more cycles that comprise operating the pump at a pressure that is lower than a normal operating pressure of the pump to eject the degassed ink through the plurality of nozzles until the missing nozzle condition ends, a threshold number of cycles have completed, or a threshold period of time is reached.

2. The marking system of claim 1, wherein the pump is a purge pump that is:
fluidly coupled to the ink reservoir, and
configured to apply pressure thereto, thus causing the ink to move from the ink reservoir to the printhead and thereby providing ink to the plurality of nozzles.

3. The marking system of claim 1, further comprising:
a purge valve coupled to the ink reservoir and configured to bleed to atmospheric pressure allowing for the ink reservoir to maintain atmospheric pressure during normal operation; and
the protocol further comprises closing the purge valve.

4. The marking system of claim 1, further comprising a peristaltic pump fluidly connected to the conduit and configured to:
during operation, draw the ink therethrough via vacuum pressure and transport the ink from the degasser to the ink reservoir via the conduit, and
act as a stop when not in operation.

5. The marking system of claim 1, wherein the missing nozzle condition comprises the control system detecting that at least a threshold amount of the plurality of nozzles are not operating.

6. The marking system of claim 1, wherein the missing nozzle condition comprises an image quality of a document printed by the marking system not meeting a threshold image quality measure.

7. The marking system of claim 1, wherein the pressure at which the pump is operated during the protocol is a pressure from about 1% to about 10% of the standard operating pressure of the pump during typical printing operations of the marking system.

8. The marking system of claim 7, wherein the pressure during the protocol is in a range of 0.25 PSI to 0.5 PSI.

9. The marking system of claim 1:
wherein the pump is a purge pump that is:
fluidly coupled to the ink reservoir, and
configured to apply pressure thereto, thus controlling the pressure applied to the ink as the ink moves from the ink reservoir to the printhead and through the plurality of nozzles; and
the system further comprises an ink supply pump that is a peristaltic pump fluidly connected to the conduit and configured to:
during operation, draw the ink therethrough via vacuum pressure and transport the ink from the degasser to the ink reservoir via the conduit, and
act as a stop when not in operation.

10. The marking system of claim 1,
wherein the protocol comprises a drool protocol; and
the control system, before initiating the drool protocol initiates a purge protocol in which the pump increases pressure applied to the one or more components of the fluid supply system, and
initiates the drool protocol after the purge protocol,
wherein during the drool protocol, the pump reduces the pressure applied to the one or more components of the fluid supply system.

11. A method of removing gas from a marking system, the method comprising:
providing a marking system comprising:
a printhead including a plurality of nozzles,
a control system, and
an ink supply system comprising:
an ink reservoir fluidly positioned to hold the ink for delivery to the printhead,
a degasser fluidly coupled to a conduit that is positioned to supply the ink from the degasser to the ink reservoir, the degasser configured to degas the ink as ink passes therethrough, and
a pump fluidly configured to provide pressure to one or more components of the fluid supply system; and
by the control system, in response to detecting a missing nozzle condition in the printhead, activating a protocol that comprises operating the pump at a pressure that is lower than a normal operating pressure of the pump to create an ink flow through the plurality of nozzles until the missing nozzle condition ends, a threshold number of cycles have completed, or a threshold period of time is reached.

12. The method of claim 11, wherein:
the pump is a purge pump that is fluidly coupled to the ink reservoir; and
activating the protocol causes purge pump to reduce the pressure applied to the ink as the ink moves from the ink reservoir to the printhead.

13. The method of claim 11, wherein:
the ink supply system further comprises a purge valve coupled to the ink reservoir and configured to bleed to atmospheric pressure allowing for the ink reservoir to maintain atmospheric pressure during normal operation; and
the protocol further comprises closing the purge valve.

14. The method of claim 11, wherein the ink supply system further comprises a peristaltic pump fluidly connected to the conduit and configured to:
during operation, draw the ink therethrough via vacuum pressure and transport the ink from the degasser to the ink reservoir via the conduit; and
act as a stop when not in operation.

15. The method of claim 11, wherein detecting the missing nozzle condition comprises detecting that at least a threshold amount of the plurality of nozzles are not operating.

16. The method of claim 11, wherein detecting the missing nozzle condition comprises detecting that an image quality of a document printed by the marking system not meeting a threshold image quality measure

17. The method of claim 11, wherein the pressure at which the pump is operated during the protocol is a pressure from about 1% to about 10% of the normal operating pressure of the pump.

18. The method of claim 17, wherein the pressure during the protocol is in a range of 0.25 psi to 0.5 psi.

19. The method of claim 11,
wherein the pump is a purge pump that is:
fluidly coupled to the ink reservoir, and
configured to control pressure applied to the ink as the ink moves from the ink reservoir to the printhead; and
the system further comprises an ink supply pump that is a peristaltic pump fluidly connected to the conduit and configured to:
during operation, draw the ink therethrough via vacuum pressure and transport the ink from the degasser to the ink reservoir via the conduit, and
act as a stop when not in operation.

20. The method of claim 11, wherein:
the protocol comprises a drool protocol; and
the method further comprises:
before initiating the drool protocol, initiating a purge protocol in which the pump increases pressure applied to the one or more components of the fluid supply system, and
initiating the drool protocol after initiating the purge protocol,
wherein during the drool protocol, the pump reduces the pressure applied to the one or more components of the fluid supply system.
